(19) United States
(12) Patent Application Publication
(10) Pub. No.: US 2006/0170623 A1
(43) Pub. Date: Aug. 3, 2006

(54) Feedback based apparatus, systems and methods for controlling emissive pixels using pulse width modulation and voltage modulation techniques

(76) Inventors: W. Edward Naugler JR., Cedar Park, TX (US); Damoder Reddy, Los Gatos, CA (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 11/304,150

(22) Filed: Dec. 14, 2005

Related U.S. Application Data
(60) Provisional application No. 60/636,430, filed on Dec. 15, 2004.

(51) Int. Cl. G09G 3/30

(52) U.S. Cl. 345/76

(57) ABSTRACT

The present invention provides techniques for emissive pixels of flat panel displays. Specifically, pixel feedback and a combination of voltage modulation and pulse width modulation are used to improve the quality and consistency of aging pixels. Based on feedback, an image frame is divided into sub-frames of various time periods. Also based on feedback, a voltage, or voltages of different voltage levels, is (are) applied to the selected sub-frames to generate an image frame of a particular gray level. The human eye integrates the effects of the voltage and pulse width modulation techniques that are applied to the various sub-frames of the image frame, over the duration of the image frame.

### RELATED APPLICATION

This application claims the benefit of U.S. Provisional Application No. 60/636,430 Dec. 15th, 2004, which is incorporated herein by reference.

### FIELD OF INVENTION

The present invention relates to emissive pixel technology for flat panel displays, and specifically to usage of pixel feedback and a combination of pulse width modulation and voltage modulation techniques for enhancing pixel emissions during the life of the pixel.

### BACKGROUND OF THE INVENTION

A new emissive type flat panel display technology called organic light emitting diode (OLED) is in the process of development by many companies around the world such as Sharp, Toshiba, Samsung, and many more. The primary technical problems with the commercialization of the OLED display are manufacturing uniformity and differential color aging over the lifetime of the display. Solutions to these problems have been presented in several pending provisional and non-provisional patent applications filed by Nuelight Corporation, the assignee of the present invention.

Two of the pending patent applications are Method and Apparatus for Controlling an Active Matrix Display (U.S. patent application Ser. No. 10/872,344) and Controlled Passive Display, Apparatus and Method for Controlling and Making a Passive Display (U.S. patent application Ser. No. 10/872,268). These applications are incorporated herein by reference. The technology developed by Nuelight uses emission feedback systems to solve the problems of OLED uniformity and differential aging in analog driven display systems.

The analog driven display is the type of drive system commonly used by the liquid crystal display (LCD) industry and by the OLED displays being developed by the major display companies cited above. In an analog driven display, different levels of analog voltages are applied to the pixel depending on the desired gray level for an image frame. There are 256 gray levels in an 8 bit display system and 65536 gray levels in a 16 bit display system. In the eight bit display system, gray level 0 represents complete darkness (black) and gray level 255 represents the brightest image frame the pixel can display.

Presently, the gray levels of a display pixel are adjusted by adjusting the voltage applied to a pixel. For example, in an 8 bit system having an image voltage source of 10 volts, 0 volts can correspond to the gray level 0 and 10 volts can correspond to the gray level 255. For all the gray levels in between 0 and 255 on the gray scale, the voltage between 0 and 10 volts is divided into 255 divisions of 39 millivolts (mv). For example, 39 mv can correspond to gray level 1 and 78 mv can correspond to gray level 2. Typically an analog to digital (A/D) converter digitizes the analog source image voltages into digital numbers between 0 and 255 (for an eight bit system). Each digital number represents a particular gray level with 0 being no pixel emission and 255 being the highest desired emission. This technique of adjusting the image source voltage to adjust the gray levels can be referred to as voltage modulation.

A problem associated with voltage modulation involves a parameter called “gamma”. In the case of displays, the term refers to the translation of the source image voltages into pixel light emission levels defining the image on the display. The problem is that in the OLED displays, there is a non-linear relationship between the emission level of the OLED and the current used by the OLED to generate that emission level. Typically, the relationship between the current and the emission level is the least linear in the low light emission levels (i.e. the shadow areas of the image). That means that the gray levels in the shadow area are squeezed together, thereby making the voltage difference between gray levels very small, and thus, subject to noise error.

Another problem with analog driven OLED displays relates to correcting aging pixels and circuits. To increase the emission from an inefficient pixel, the voltage must be increased to that pixel or the voltage must be decreased to all the other pixels. Because gray shades are manipulated with a digital number of a certain number of bits (e.g. 8 bits for 256 levels of gray shades), if a higher voltage is required by an aged pixel to achieve the highest brightness, a 257^{th} level of gray would have to be assigned. That would require 9th bit, but only 8 bits are available in an 8 bit system.

The apparatus, systems and methods of the present invention resolve the shadow area problem and reduce the number of required system bits for voltage modulation while increasing the number of gray scale levels. The apparatus, systems and methods of the present invention are applicable generally to the emissive pixels, and especially to the emissive pixels used in flat panel displays.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 illustrates an exemplary functional block diagram of the display system of the present invention;

FIG. 2 illustrates another exemplary functional block diagram of the display system of the present invention;

FIG. 3 illustrates an exemplary embodiment of the pixel circuitry of the present invention;

FIG. 4 illustrates another exemplary embodiment of the pixel circuitry of the present invention;

FIG. 5 illustrates an exemplary timing diagram for image sub-frames of an image frame of the present invention; and

FIG. 6 illustrates another exemplary timing diagram for image sub-frames of an image frame of the present invention.

### DETAILED DESCRIPTION OF THE INVENTION

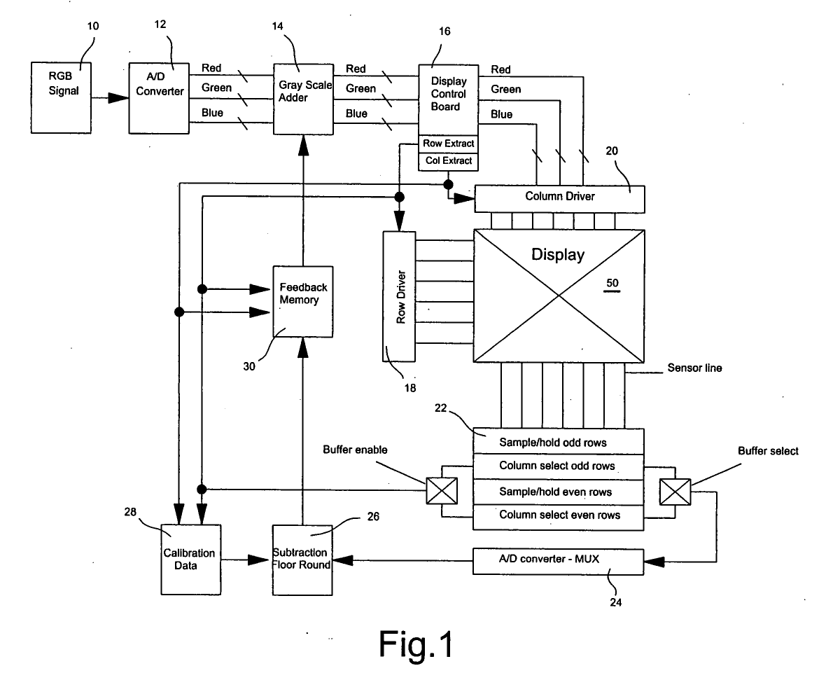

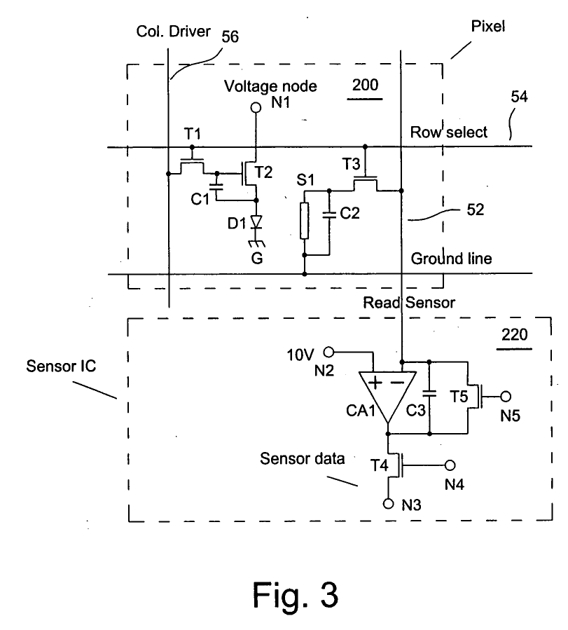

The present invention uses the emissive feedback described in the above-mentioned patent applications. FIG. 1 shows a functional diagram of an embodiment of the system (100) of the present invention. An analog image signal (block 10) is sent to the analog-to-digital (A/D) converter (block 12) where the analog voltage signals are digitized to numbers between 0 and 255 in an 8 bit gray level display. The number indicates the gray scale level required by the image data. The digitized data is then sent to the Gray Scale Adder (block 14) where zero, one or more gray levels are added to the digitized image data according to the aging status of the particular pixel in question. The Display Control Board (block 16) controls the display 50 by managing the timing of data movement and column and row timing by using the Row Driver (block 18) and the Column Driver (block 20). The digitally corrected image data is converted by the gamma table in the Display Control Board (block 16) to a digital voltage, which will be converted by the column driver function to an analog voltage to be down loaded to the OLED pixel circuitry 200 shown in FIG. 3.

As shown in the exemplary embodiment of FIG. 3, the voltage data is loaded by using the Column Driver line 56 through the thin film transistor (TFT) T1 onto capacitor C1 and the voltage applied to the gate of TFT T2. TFT T2 can be referred to as the current supply TFT for OLED D1. Simultaneously with the turning on of TFT T1 by using the Row Select line 54, TFT T3 is also turned on and charge from the sensor line 52 moves into C2 causing a voltage to appear on the output of the charge amplifier CA1. The voltage on the charge amplifier CA1 is read on node N3 when the field effect transistor (FET) T4 is turned on. The circuitry shown in FIG. 3 can be implemented with N type or P type transistors. The circuitry shown in FIG. 3 can be implemented with amorphous silicon or poly silicon.

The sensor voltage is stored in the sample and hold functions (block 22) shown in FIG. 1 and then run through an A/D converter (block 24) and multiplexed (MUXed) to a serial data stream that is sent to the subtraction function (block 26). Sensor data is subtracted from the calibration data (block 28), and if the result is less than one gray level, a zero is stored in the feedback memory (block 30) for the pixel in question and no change is made during the display of the subsequent image frame to the image data for that pixel. If, however, the result is greater than one gray level, then a “1” is sent to the feedback memory (block 30), which is added to the image gray level, thereby increasing the brightness on an aged pixel that has lost some of its efficiency. Managing the gray levels for the display 50 is important because it is by modifying the gray levels, either with additional voltage or with additional gray levels, that the brightness of aged pixels can be brought back to the original emission levels as they age.

In one aspect of the present invention, pulse width modulation (PWM) instead of voltage modulation is used to change gray levels in display pixels using the OLED technology, or any other type of display media or material such as LCD, electroluminescent, or plasma. The pulse width modulation of the present invention allows for changing the gray levels of pixels in all regions of the gray scale, including, for example, the shadow regions where there is a non-linear relationship between the drive current and the light emission for the OLED. Because of the non-linear relationship between the OLED current and light emission in the shadow area of the gray scale, it is difficult to effectively and accurately adjust the gray level of a pixel simply by adjusting the voltage provided to the pixel.

By using pulse width modulation instead of voltage modulation, a high current can be applied to the OLED material all the time regardless of the gray scale region in which the gray level adjustment needs to be made. That avoids the complication of having to adjust the applied current to the OLED in the gray scale regions in which there is a nonlinear relationship between the current and light emission, for example, in the shadow areas. Gray scale is achieved with pulsed light that is pulsing faster than the human eye can follow. When this happens, the eye integrates the pulsed light over a time period, for example, 16.7 milliseconds (ms) frame time in a 60 frames per second (fps) system. If the PWM (pulse width modulated) system is an 8 bits system, there are 256 levels of gray from black (off) to maximum brightness at the maximum voltage. In the voltage modulated system, the voltage may run from 0 volts for black to 10 volts for maximum brightness. In the system having 256 levels in the gray scale, the average voltage interval from level to level in a linear system would be 39 mv. But Gray scale systems are typically non-linear and the intervals between gray levels in the shadow areas may only be a few millivolts (mv) or less.

The present invention includes various techniques of producing pulse width modulation of image data using emissive feedback. Emissive feedback is described in detail in the above-mentioned patent applications, which are incorporated herein by reference. The techniques involve sub-frame modulation. Each image frame is sub-divided into a number of sub-frames. In one embodiment, the image frame is divided into 8 sub-frames (for an eight bit grayscale) having a binary relationship to each other. That is, sub-frame one is one time unit long; sub-frame 2 is two time units long; sub-frame 3 is 4 time units long; sub-frame 4 is 8 time units long; sub-frame 5 is 16 time units long; sub-frame 6 is 32 time units long; sub-frame 7 is 64 time units long; and sub-frame 8 is 128 time units long.

By combining the sub-frames, any gray level between 0 and 255 can be created. During operation, the refresh level of the display 50 is run at the frame rate times the number of sub-frames. Thus, for a frame rate of 60 per second, the sub-frame rate is 480 sub-frames per second. In each sub-frame, a determination is made whether or not the pixel is to be on. For example, if the gray level is the 150^{th}, the binary number representing that gray level is 10010110. Thus, the pixel is off during the first sub-frame, on during the second sub-frame, on during the third sub-frame; off during the forth sub-frame; on during the fifth sub-frame; off during the sixth sub-frame; off during the seventh sub-frame and on during the eighth and last sub-frame. The gray scale is created by the fact that the human eye cannot distinguish flashes faster than about 30 flashes per second. The brain interprets flashes faster than 30 per second as shades of gray determined by the duty factor for the flashes and the intensity of the flashes.

In this specification, the embodiments of the present invention are described for a display having pixels organized in 480 columns and 320 rows (HVGA), but the invention is applicable to displays having any number of columns and rows of pixels.

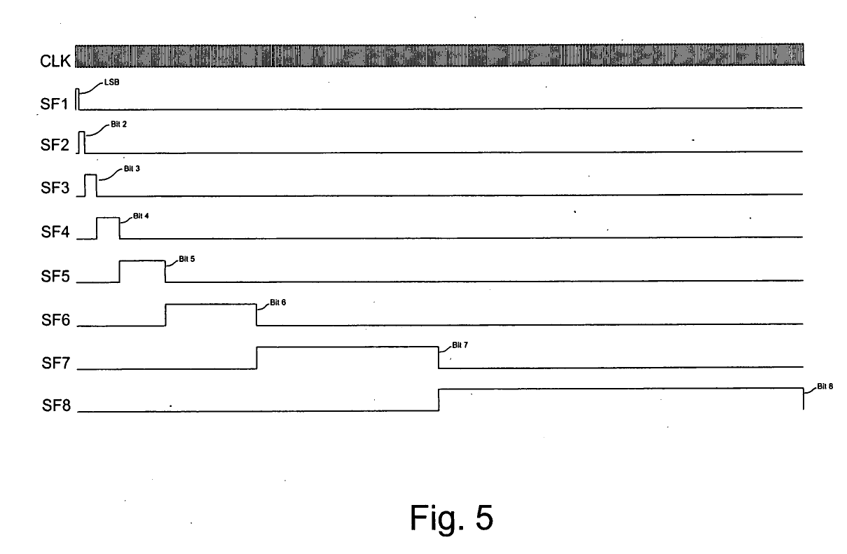

The above embodiment can be referred to as the full pulse width modulated system. In this system, the gray levels are determined purely by the use of varying the time the pixel is on during the frame time of the image. FIG. 5 shows the timing diagram for the gate enable line for each of the 8 sub-frames (SF) per frame. SF1 is the shortest time on and represents the least bit or first gray level. In FIG. 3, the in-pixel circuit 200 is shown with the off-glass sensor integrated circuit (IC) 220. A row of the display pixels is selected by making the Row Select line 54 high. This action turns on both T1 and T3 at the beginning of the row address time. In a sub-frame modulated system, the sub-frame duration is different for each sub-frame and the total of all the sub-frames must add up to the frame rate. If the frame rate is 60 frames per second, the frame time is 16.7 milliseconds (ms).

The sub-frame rate for the first (shortest) sub-frame is the frame rate divided by the result of multiplying the number of lines (320) times the number of gray levels. For example, in an 8 bit system there are 255 levels of gray (if zero is not counted as a level). This means that the address time for the first sub-frame is 16.7 ms divided by 255×320 or approximately 200 nanoseconds. When T1 and T3 are simultaneously turned on, charge flows from the sensor line into C3 causing a voltage to appear on the output pin of charge amplifier CA1.

That voltage represents the state of C2, which has integrated the photon emission from the pixel for the previous sub-frame. The second sub-frame, SF2, is twice as long as the first and therefore, the address time is 400 nanoseconds. The third sub-frame is twice as long as its predecessor and therefore, 800 nanoseconds long. The rest of the sub-frames double their predecessors accordingly and the last sub-frame has half the frame time of approximately 25 microseconds. In this embodiment, the sensor is read out after each sub-frame. This is because the sensor TFT T3 and the data line TFT T1 are coupled together. Each gray level down loads the pixel turn-on voltage according to which sub-frames add up to the desired gray level. For example, for the zero level, no voltage is downloaded during any of the sub-frames. For the first gray level, voltage is downloaded for the first sub-frame but none of the others. For the second gray level, voltage is down loaded only for the second sub-frame which leaves the pixel on for twice as long as the first gray level, and thus, to the perception of the eye the second gray level is twice as bright as the first. For gray level 10, the second sub-frame and the forth sub-frame have voltage downloaded to the pixel. For the brightest gray level, voltage is downloaded to the pixel during all the sub-frames, leaving the pixel on for the total time.

As the pixels age, either more voltage can be downloaded to the pixel or the on-times of the sub-frames can be expanded. In the embodiment above, the 8 bit sub-frames fill the whole frame time, and therefore, to compensate for aging pixels, the downloaded voltage is increased. In an alternate embodiment, the sub-frames fill only half the frame time. In the eight bit system of that embodiment, the first sub-frame address time is 100 nanoseconds and the last bit address time is 12.5 microseconds. Since only half the frame time is used, it allows the use of an additional bit expanding the gray levels to 512. The last bit is now 26 microseconds. In this embodiment, the aged pixel compensation is gained by using the last gray level of 26 microseconds duration in combination with the other 8 bits.

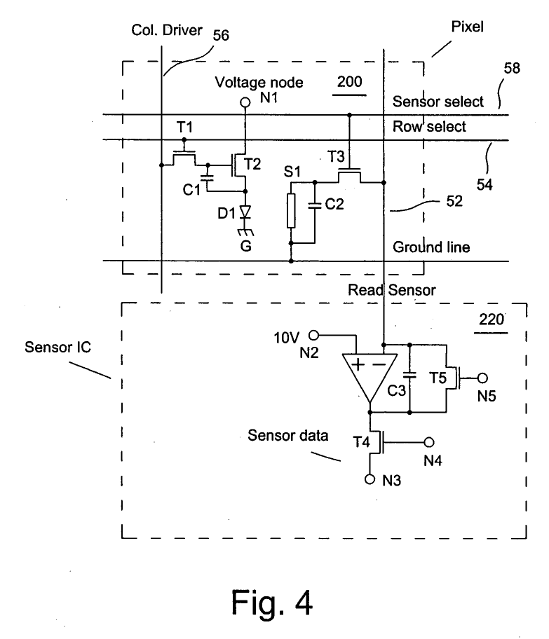

In another embodiment, shown in FIG. 4, the enable line for the data 54 is separated from the enable line for the sensor 58. By adding the separate sensor enable line 58, the sensor can now be read out independently of the gate enable line for T1 54; therefore, the sensor line 52 can be read out after all the sub-frames have been executed allowing the sensor to integrate the emission over the total frame time. This produces a large charge to measure, and thus, greater signal to noise ratio. This embodiment can be used with either of the first two embodiments.

In another embodiment, the system of the present invention uses 255 sub-frames (in a 8 bit system), each frame having the same length. The gray scale is determined by during how many sub-frames is the voltage downloaded to the pixel. Thus, for a gray scale of 10, only during the first ten sub-frames, or any ten sub-frames, the voltage is downloaded to the pixel. During the 245 sub-frames, zero volts are downloaded to the pixel. For a gray level of 200, voltage is downloaded to the pixel during 200 sub-frames, but not during the other 155 frames.

The present invention also uses apparatus, systems, methods, in which combinations of pulse width modulation and voltage modulation techniques are used. In the pulse width modulation techniques discussed above, the voltage downloaded to the pixel was either zero or a constant voltage. In using a combination of voltage modulation and PWM, the voltage is either zero for black or one of several possible voltages.

In one embodiment, the system includes five voltage bits and four pulse width modulation bits. In that embodiment 32 different voltage levels are possible and 16 different pulse width modulations are possible. In that embodiment, 466 different gray levels are possible according to the formula:
G_{L}:=(2^{·B}^{_{V}}−1)·(2^{B}^{_{H}}−1)+1

G_{L} stands for the number of gray levels, B_{V} stands for the number of voltage bits and B_{H} stands for the number of pulse width modulation bits.

The system of this embodiment of the present invention requires only 5 voltage modulation bits, whereas 8 bits are required in the present analog driven systems. In a 5 bit system, 32 different voltage levels are available. A 10 volt system would have 312 mV between levels. The 8 bit system has only 39 mV between levels. Five bits are less vulnerable to noise error than 8 bits and are also more power and cost effective than 8 bits. Also, the separation between voltage levels in the 5 bit system is 8 times larger than for an 8 bit system. In this embodiment, the 466 gray levels, which are many more than the 256 levels of the 8 bit voltage modulation embodiment, provide for increasing the emissions of the aging pixels to the highest levels of the gray scale, without losing gray levels for the less aged pixels.

An advantage of such a system is that the combined number of system bits is less than the addition of the voltage bits and the pulse width bits. This is so because both the voltage modulation bits and the pulse width modulation bits cannot use the zero, and therefore, for example, the four bit pulse width modulation system only has 15 gray levels instead of 16.

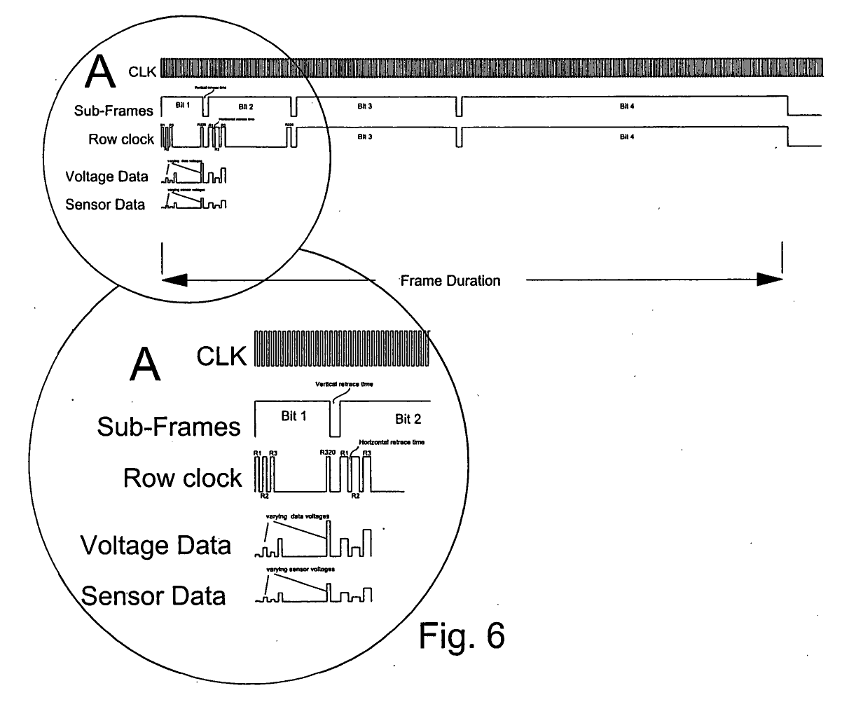

The purpose of the system of this embodiment, which can be referred to as the bit splitting system, is to combine the pulse width modulation with voltage modulation in order to reduce the number of voltage modulation bits required for the gray scale. In other words, the bits are split between voltage modulation and pulse width modulation. For this example, as shown in FIG. 6, four bits are used for the pulse width levels. Using the same 480 columns×320 rows display, the first pulse width bit is 16 times longer than in the 8 bit full pulse width modulation embodiment discussed earlier; therefore, the address time is 3.2 microseconds. The last pulse bit is 25.6 microseconds. For this example, the voltage modulation bits are reduced from 8 to 5, giving 466 levels of gray for the aged pixels to expand into. FIG. 6 shows the sub-frame timing. Each sub-frame is separated in time by the vertical retrace time. Inside of each sub-frame, the row clock enables the gate line for the address time; therefore, within each sub-frame 320 rows have data downloaded to them.

The row durations are separated by the horizontal retrace time. The row duration is the shortest for the first sub-frame (bit 1) and as the sub-frames lengthen, the address time increases but the horizontal retrace time stays the same. Section A of the drawing is enlarged to show the detail of the voltage data and the sensor data. The sensor data is measured as volts on the output of charge amp CA1. The sensor voltages are proportional to the data voltages, but not the same amplitudes. In actuality, the sensor voltage can be many times less than the data voltages, but there will always be a proportional relationship.

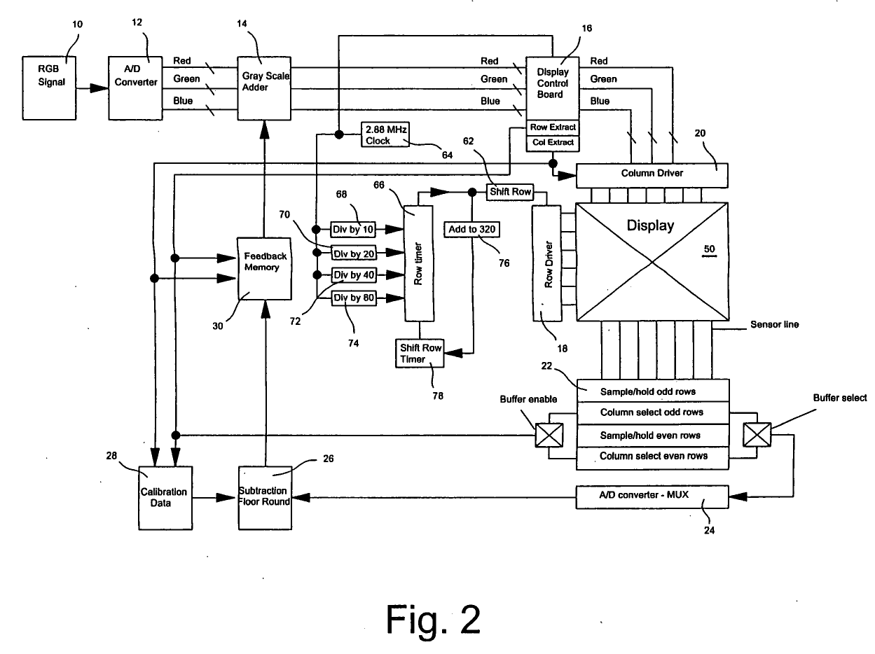

FIG. 2 shows an embodiment of a split bit driving system. The functional diagram is similar to the diagram shown in FIG. 1 with the addition of the row driving system, which must handle non-regular sub-frame times and non-regular row address times. The circuits to implement the system are well known in the industry. To design the system, the shortest row address time is first calculated. Therefore, in a 60 frames per second, 320 line display, using a four bit sub-frame modulation system the shortest row address time is 1/(60×320×15)=3.472222 microseconds. In one embodiment, a Clock 64 period of ten times faster than the short address time is used. This is a Clock 64 frequency of 2.88 MHz. At 50% duty cycle, the Clock 64 produces a pulse every 0.3472222 microseconds. The Row Driver 18 contains a shift register that shifts the gate voltage from row to row on command from the Shift Row function 62.

The Shift Row function 62 sends a shift row pulse to the Row Driver 18 every time a pulse arrives from the Row Timer 66. Initially the Row Timer 66 passes the Clock 64 signal divided by 10, “Div by 10” 68 signals to the Shift Row function 62 causing the Row Driver 18 to shift from row to row at the address rate of 3.47222 microseconds per row. The “Add to 320” counter function sends a Shift Row Timer 78 pulse every time it counts 320 pulses coming from the Row Timer function. Every time the “Add to 320” function 76 counts 320 pulses, a sub-frame is completed. Since the first sub-frame used 3.47222 microsecond pulses the first sub-frame time is 3.47222 microseconds×320=1.111 milliseconds for sub-frame bit 1. When the pulse arrives from the “Add to 320” function 76 after the first sub-frame is completed, the Row Timer 66 shifts to the 2.88 MHz Clock 64 “Divide by 20” 70 signal which now sends pulses to the Shift Row function 62 at the rate of 0.144 MHz. This is a row address time of 6.9444 microseconds. After 320 row pulses the sub-frame time for bit 2 is 6.9444 microseconds×320=2.222 milliseconds, which is two times the sub-frame rate bit 1, the Row Timer 66 shifts to the “Divide by 40” 72 signal and the sub-frame time bit 3 is 4.4444 milliseconds, which is twice that of sub-frame 2 and four times sub-frame bit 1.

Finally, the Row Timer 66 shifts to the “Divide by 80” 74 signal and the last sub-frame bit 4 takes 8.8888 milliseconds to complete. Adding up the four sub-frame times comes to 16.67 milliseconds, which is the frame time. At the start of the next frame, the Row Timer 66 is reset to the “Divide by 10” 68 signal and the next frame proceeds to display.

During the address time for each line, 5 bit voltage data is sent to each row and column. The voltage data is not either off for black and a fixed voltage, but a voltage between 0 and ten volts in 32 steps. Nominally the 10 volts is split into 32 steps of 312.5 millivolts. However, the relationship of volts to current supplied by TFT T3 to the OLED is not linear, nor is the OLED's response to current linear; therefore, the steps are not equidistant but are more compressed in the low gray scale area.

Although preferred illustrative embodiments of the present invention are described above, it will be evident to one skilled in the art that various changes and modifications may be made without departing from the invention. The respective embodiments described above are concrete examples of the present invention; the present invention is not limited to these examples alone. The claims that follow are intended to cover all changes and modifications that fall within the true spirit and scope of the invention.

1. A method for displaying a frame of an image on a display using an emissive pixel comprising:
determining the total time period for displaying the frame;
dividing the total time period into a series of time sub-divisions;
selecting some of the time sub-divisions from the series of time sub-divisions;
causing the emissive pixel to display the image on the display during the selected time sub-divisions; and
not causing the emissive pixel to display the image on the display during the other time sub-divisions; wherein,
causing the emissive pixel to display the image on the display by applying a voltage to the emissive pixel.

2. The method of claim 1, wherein the total time period for displaying the frame includes approximately 16.7 milliseconds.

3. The method of claim 1, wherein the time sub-divisions of the series are progressively large.

4. The method of claim 1, wherein the total time period for displaying the frame is divided into a series of eight time sub-divisions.

5. The method of claim 3, wherein the first sub-division includes one unit of time, the second sub-division includes two units of time, the third sub-division includes four units of time, the fourth sub-division includes eight units of time, the fifth sub-division includes sixteen units of time, the sixth sub-division includes thirty two units of time, the seventh sub-division includes sixty four units of time and the eighth sub-division includes one hundred and twenty eight units of time.

6. The method of claim 1, wherein selecting the time sub-divisions for displaying the image depending on the desired gray scale value of the image.

7. The method of claim 1, wherein applying the same voltage to the emissive pixel during all the selected time sub-divisions.

8. The method of claim 1, wherein applying different voltages to the emissive pixel during the different selected time sub-divisions.

9. The method of claim 1, wherein the total time period for displaying the frame is divided into a series of two hundred and fifty five time sub-divisions.

10. The method of claim 9, wherein each of the two hundred and fifty five sub-divisions includes the same amount of time.

11. The method of claim 1, wherein applying the voltage to the emissive pixel during only a part of the time sub-division of a selected time division.

12. The method of claim 1, wherein the total time period for displaying the frame is divided into a series of four time sub-divisions.

13. The method of claim 12, wherein applying different voltages to the emissive pixel during the different selected time sub-divisions.

14. The method of claim 1, further comprising:
receiving a feedback signal indicative of the light emitted by the emissive pixel;
comparing the feedback signal with a threshold; and
selecting the time subdivisions based on the result of the comparison.

15. The method of claim 1, further comprising:
receiving a feedback signal indicative of the light emitted by the emissive pixel;
comparing the feedback signal with a threshold; and
applying various voltages to the emissive pixel based on the result of the comparison.

16. The method of claim 1, further comprising:
receiving a feedback signal indicative of the light emitted by the emissive pixel;
comparing the feedback signal with a threshold;
selecting the time subdivisions based on the result of the comparison; and
applying various voltages to the emissive pixel based on the result of the comparison.

17. The method of claim 16, wherein applying voltages to the emissive pixel only during the selected time subdivisions.

18. A display system comprising:
an emissive pixel;
a sensor embedded in the emissive pixel;
a feedback signal line coupled to the sensor;
a feedback circuit coupled to the feedback signal line for receiving a feedback signal from the sensor indicative of the light emitted by the pixel and comparing the feedback signal with a threshold;
an image frame;
a first circuit for dividing the image frame into a plurality of image sub-frames;
a voltage source coupled to the pixel;
a second circuit for selecting some of the plurality of the image sub-frames based on the result of the comparison; and
a third circuit for applying a voltage of the voltage source to the emissive pixel during the selected image sub-frames for displaying the image frame on the display.

19. The display system of claim 18, further comprising:
a first set of a plurality of binary bits, each bit representing a different one of the image sub-frame;
the second circuit for assigning each bit of the first set a first or a second binary value;
a second set of a plurality of binary bits for determining a voltage level; and
the third circuit for applying the voltage level determined by the second set of the plurality of binary bits to the emissive pixel during an image sub-frame represented by a binary bit from the first set of the plurality of binary bits having the first binary value.

20. The display system of claim 19, wherein the first set of the plurality of binary bits includes four binary bits.

21. The display system of claim 19, wherein the second set of the plurality of binary bits includes five binary bits.

22. The display system of claim 19, further comprising:
the third circuit for applying different voltages to the emissive pixel during the different image sub-frames.

23. A display system comprising:
an emissive pixel;
a sensor embedded in the emissive pixel;
a feedback signal line coupled to the sensor;
a feedback circuit coupled to the feedback signal line for receiving a feedback signal from the sensor indicative of the light emitted by the pixel;
an image frame;
a first circuit for dividing the image frame into a plurality of image sub-frames;
a voltage source coupled to the pixel;
a second circuit for selecting some of the plurality of the image sub-frames; and
a third circuit for applying a voltage of the voltage source to the emissive pixel during the selected image sub-frames for displaying the image frame on the display;
an integration circuitry for integrating values of the feedback signal received by the feedback circuit during the displaying of the image frame on the display; and
a fourth circuit for comparing a result of the integration with a threshold; wherein
the third circuit for adjusting a voltage applied to the emissive pixel based on the comparison.

24. The display system of claim 23, further comprising:
a fifth circuit for enabling the feedback signal line during the displaying of an image frame; and
the fifth circuit for disabling the feedback signal line following the displaying of the image frame.

25. The display system of claim 23, wherein the third circuit for increasing the voltage applied to the emissive pixel if the result of the integration is less than the threshold.
